(19) United States
(12) Patent Application Publication
(10) Pub. No.: US 2015/0144714 A1
(43) Pub. Date: May 28, 2015

(54) Spray Bottle

(71) Applicant: Sheila S. Pirtle, Decatur, AL (US)

(72) Inventor: Sheila S. Pirtle, Decatur, AL (US)

(21) Appl. No.: 14/087,686

(22) Filed: Nov. 22, 2013

(51) Int. Cl. B05B 11/00

(52) U.S. Cl. CPC B05B 11/0037
USPC 239/302

(57) ABSTRACT

A spray bottle comprises a bottom portion defining a generally cylindrical container having a first diameter and with an opening defined by a threaded lip having a second diameter slightly less than that of the first diameter, and a top portion comprising a neck portion and a generally cylindrical portion with threaded opening dimensioned to threadably engage said threaded lip of the bottom portion, and where the first diameter is at least about 50% greater than the dimension of the neck portion.

### BRIEF DESCRIPTION OF THE DRAWINGS

The apparatus is described with reference to the accompanying drawings. In the drawings, like reference numbers indicate identical or functionally similar elements.

FIG. 1 illustrates a spray bottle according to one embodiment; and

FIG. 2 illustrates a spray bottle according to another embodiment.

### DETAILED DESCRIPTION

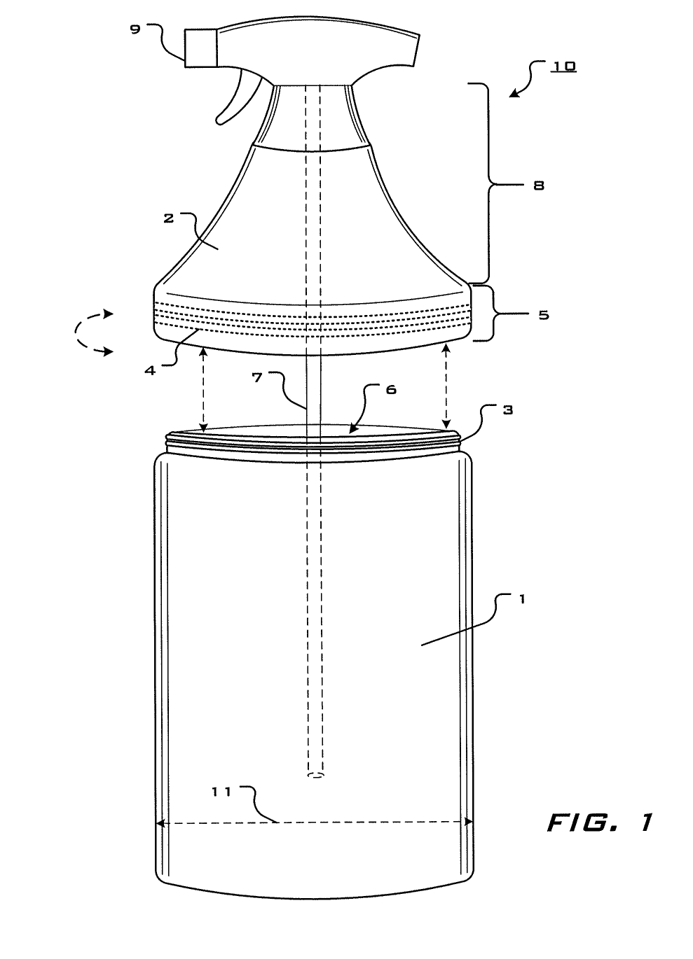

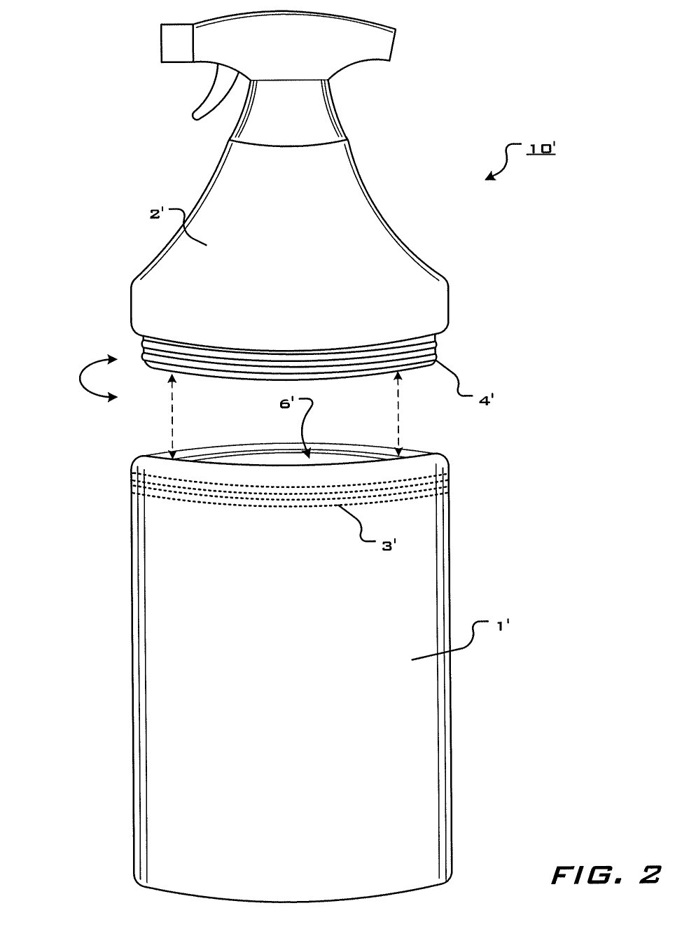

The various embodiments and their advantages are best understood by referring to FIGS. 1 and 2 of the drawings. The elements of the drawings are not necessarily to scale. Throughout the drawings, like numerals are used for like and corresponding parts of the various drawings.

FIG. 1 depicts a spray bottle 10 having a bottom container portion 1 adapted to contain a fluid to be sprayed and a top portion 2 configured with a spray mechanism 9 with a trigger for drawing the fluid from the bottom portion through tube 7 in the conventional manner and spray it out. The top portion 2 also comprises a neck portion 8 which is sufficiently narrow to be comfortably held in an adult hand such that the index finger of which may operate the trigger of the spray mechanism 9.

In this embodiment, the container portion 1 is generally cylindrical having a first diameter 11 that is at least 50% greater than the dimensions of the neck portion 8 with an opening 6 defined by a male threaded portion 3. The opening 6 defines a wide mouth having a diameter slightly less than that of the remainder of the container portion 1. The top portion 2 includes a general cylindrical portion 5 that includes an opening defined by a female threaded portion 4. The female threaded portion 4 is dimensioned to threadably engage the male threaded portion 3 in the usual manner and snugly mate the bottom container portion 1 to the top portion 2.

FIG. 2 depicts an embodiment nearly identical to the first, but which the bottom portion 1′ comprises a female threaded portion 3′ and the top portion 2′ comprises a male threaded portion 4′.

As described above and shown in the associated drawings, the present invention comprises a spray bottle. While particular embodiments have been described, it will be understood, however, that any invention appertaining to the apparatus described is not limited thereto, since modifications may be made by those skilled in the art, particularly in light of the foregoing teachings. It is, therefore, contemplated by the appended claims to cover any such modifications that incorporate those features or those improvements that embody the spirit and scope of the invention.

What is claimed is:

1. A spray bottle comprising:
a bottom portion defining a generally cylindrical container having a first diameter and with an opening defined by a threaded lip having a second diameter slightly less than that of the first diameter; and
a top portion comprising a spray mechanism extending from a neck portion, the neck portion having a sufficiently narrow to be comfortably held by hand and allow operation of the spray mechanism, said top portion further comprising a generally cylindrical portion with threaded opening dimensioned to threadably engage said threaded lip of said bottom portion; and
wherein the first diameter is at least about 50% greater than the dimension of the neck portion.
